(19) United States
(12) Patent Application Publication
(10) Pub. No.: US 2023/0006188 A1
(43) Pub. Date: Jan. 5, 2023

(54) ENERGY STORAGE DEVICE

(71) Applicant: GS YUASA INTERNATIONAL LTD., Kyoto-shi, Kyoto (JP)

(72) Inventors: Ukyo HARINAGA, Kyoto-shi, Kyoto (JP); Masashi TAKANO, Kyoto-shi, Kyoto (JP); Kenta UEHIRA, Kyoto-shi, Kyoto (JP); Tomonori KAKO, Kyoto-shi, Kyoto (JP)

(21) Appl. No.: 17/784,562

(22) PCT Filed: Dec. 15, 2020
(86) PCT No.: PCT/JP2020/046624

§ 371 Date: Jun. 10, 2022

(30) Foreign Application Priority Data
Dec. 18, 2019 (JP) 2019-228677

(51) Int. Cl. H01M 4/133; H01M 4/66; H01M 4/587; H01M 10/0525; H01M 10/0587; H01G 11/32

(52) U.S. Cl. CPC H01M 4/133; H01M 4/662; H01M 4/587; H01M 10/0525; H01M 10/0587; H01G 11/32; H01M 2004/027

(57) ABSTRACT

An energy storage device according to an aspect of the present invention includes: a negative electrode including a negative substrate made of pure aluminum or an aluminum alloy, a conductive layer directly or indirectly layered on the negative substrate and containing a conductive agent, and a negative active material layer containing a negative active material capable of occluding lithium ions at a potential of 0.05 V vs. Li/Li⁺ or lower; and a positive electrode opposed to the negative electrode and including a positive substrate and a positive active material layer directly or indirectly layered on the positive substrate, and the negative active material layer is layered on the negative substrate and the conductive layer so as to include a region in contact with the negative substrate and a region in contact with the conductive layer.

### TECHNICAL FIELD

The present invention relates to an energy storage device.

### BACKGROUND ART

Energy storage devices typified by lithium ion nonaqueous electrolyte solution secondary batteries are widely used for electronic devices such as personal computers and communication terminals, motor vehicles, and the like since these secondary batteries have a high energy density. The energy storage device is generally provided with an electrode assembly, having a pair of electrodes electrically isolated by a separator, and a nonaqueous electrolyte solution interposed between the electrodes and is configured to perform charge-discharge by transferring ions between both the electrodes. Capacitors such as lithium ion capacitors and electric double-layer capacitors are also widely in use as energy storage devices except for the nonaqueous electrolyte solution secondary batteries.

As a negative electrode material for such an energy storage device, the use of an aluminum foil that has a surface coated with carbon is proposed (see Patent Document 1).

### PRIOR ART DOCUMENT

### Patent Document

Patent Document 1: JP-A-2012-174577

### SUMMARY OF THE INVENTION

### Problems to be Solved by the Invention

In an energy storage device with an aluminum foil used as a negative electrode material, even when an excessive amount of electric current flows through the negative electrode to such an extent that metal lithium is deposited, a lithium-aluminum alloying reaction is developed, thereby allowing the deposition of metal lithium dendrite to be inhibited. In an energy storage device in which an aluminum foil provided with a conductive layer such as carbon coat on the surface of the aluminum foil is used as a negative electrode material, a reaction of metal lithium dendrite deposition may be possibly generated preferentially rather than a lithium-aluminum alloying reaction in the case of charge (overcharge) beyond the charged state in normal use. This is because the presence or absence of the conductive layer affects the supply rate of lithium ions onto the negative substrate, but does not affect the supply rate of lithium ions to the negative active material. If any metal lithium dendrite is produced, the temperature of the energy storage device may be possibly increased rapidly. For this reason, the further improved safety of the energy storage device in the overcharged state is desired.

The present invention has been made in view of the foregoing circumstances, and an object of the present invention is to provide an energy storage device capable of further improving safety at the time of overcharge.

### Means for Solving the Problems

An aspect of the present invention made for solving the problems mentioned above is an energy storage device including: a negative electrode including a negative substrate made of pure aluminum or an aluminum alloy, a conductive layer directly or indirectly layered on the negative substrate and containing a conductive agent, and a negative active material layer containing a negative active material capable of occluding lithium ions at a potential of 0.05 V vs. Li/Li⁺ or lower; and a positive electrode opposed to the negative electrode and including a positive substrate and a positive active material layer directly or indirectly layered on the positive substrate, where the negative active material layer is layered on the negative substrate and the conductive layer so as to include a region in contact with the negative substrate and a region in contact with the conductive layer.

### Advantages of the Invention

According to the present invention, it is possible to provide an energy storage device capable of further improving safety at the time of overcharge.

### BRIEF DESCRIPTION OF THE DRAWINGS

FIG. 1 is a schematic diagram illustrating the appearance of an energy storage device according to an embodiment of the present invention.

FIG. 2 is a schematic perspective view schematically illustrating an electrode assembly of an energy storage device according to an embodiment of the present invention.

FIG. 3 is a partial cross-sectional view schematically illustrating a part of an electrode assembly of an energy storage device according to an embodiment of the present invention.

FIG. 4 is a partial cross-sectional view schematically illustrating a part of an electrode assembly of an energy storage device according to another embodiment of the present invention.

FIG. 5 is a schematic view illustrating an energy storage apparatus configured by aggregating a plurality of energy storage devices according to one embodiment of the present invention.

### MODE FOR CARRYING OUT THE INVENTION

An energy storage device according to an embodiment of the present invention includes: a negative electrode including a negative substrate made of pure aluminum or an aluminum alloy, a conductive layer directly or indirectly layered on the negative substrate and containing a conductive agent, and a negative active material layer containing a negative active material capable of occluding lithium ions at a potential of 0.05 V vs. Li/Li⁺ or lower; and a positive electrode opposed to the negative electrode and including a positive substrate and a positive active material layer directly or indirectly layered on the positive substrate, and the negative active material layer is layered on the negative substrate and the conductive layer so as to include a region in contact with the negative substrate and a region in contact with the conductive layer.

The energy storage device is capable of further improving safety at the time of overcharge. Although the reason for this is not clear, the following reason is presumed. In the energy storage device, the negative active material layer is layered on the negative substrate and the conductive layer so as to include a region in contact with the negative substrate and a region in contact with the conductive layer. In addition, the energy storage device includes the negative substrate made of pure aluminum or an aluminum alloy, and the negative active material layer contains a negative active material that is capable of occluding lithium ions at a potential of 0.05 V vs. Li/Li⁺ or lower, that is, has a possibility of metal lithium deposition in the case of charge at a high current density. Thus, when the charged state of the energy storage device is increased, the negative potential is likely to be lower than the potential at which a lithium-aluminum alloying reaction is developed in the region with the negative active material layer in contact with the negative substrate. For this reason, when the energy storage device is overcharged, the above-mentioned lithium-aluminum alloying reaction is likely to proceed in the region with the negative active material layer in contact with the negative substrate, thereby inhibiting the deposition of metal lithium, and thus, the safety of the energy storage device at the time of overcharge can be further improved.

As viewed in the direction in which the negative electrode and the positive electrode are opposed to each other, an end edge of the conductive layer is preferably protruded toward an outer edge side from an end edge of the positive active material layer. In a region of the negative active material layer formed on the conductive layer, the lithium-aluminum alloying reaction in the negative substrate is inhibited by the conductive layer interposed. In addition, in a normal use, lithium ions move in the region where the positive active material layer and the negative active material layer face are opposed to each other. The end edge of the conductive layer is protruded toward the outer edge side from the end edge of the positive active material layer as viewed in the direction in which the negative electrode and the positive electrode are opposed to each other, thereby leading to the conductive layer layered in the region of the negative active material layer opposed to the positive active material layer, and thus, in normal use, lithium ions are kept from reaching the negative substrate, and the lithium-aluminum alloying reaction in the negative substrate is inhibited. Because the lithium-aluminum alloying reaction is likely to be developed in the case of charge at a high current density, the energy storage device is particularly effective in the case of charge under conditions of, for example, 5 C or higher.

Preferably, the device further includes a negative electrode external terminal and a positive electrode external terminal that each conduct electricity to an external, the negative substrate has a negative electrode connection connected to the negative electrode external terminal, and a region of the negative active material layer in contact with the negative substrate is located on the negative electrode connection side of the negative substrate. In the energy storage device, the lithium-aluminum alloying reaction of the negative substrate proceeds on the negative electrode connection side connected to the negative electrode external terminal, thereby significantly increasing the electrical resistance of the negative substrate. The electric resistance of the negative substrate is significantly increased on the negative electrode connection side connected to the negative electrode external terminal, thereby improving an inhibiting effect on the generation of a further charge current at the time of overcharge, and allowing safety at the time of overcharge to be further enhanced.

The negative active material is preferably hardly graphitizable carbon or easily graphitizable carbon. The hardly graphitizable carbon or the easily graphitizable carbon has a higher discharge capacity at a potential that is higher than the potential at which the lithium-aluminum alloying reaction is developed, as compared with other carbon materials such as natural graphite or artificial graphite. The negative active material is hardly graphitizable carbon or easily graphitizable carbon, thereby allowing the capacity density of the energy storage device to be increased when pure aluminum or an aluminum alloy is used for the negative substrate.

Hereinafter, an energy storage device according to an embodiment of the present invention will be described in detail with reference to the drawings.

### <Energy Storage Device>

Hereinafter, as an example of the energy storage device, an energy storage device which is a nonaqueous electrolyte secondary battery will be described. The energy storage device includes: an electrode assembly that has a negative electrode and a positive electrode stacked; a negative current collector joined to the negative substrate; a nonaqueous electrolyte solution containing lithium ions; and a case that houses the electrode assembly, the negative current collector, and the nonaqueous electrolyte solution. The electrode assembly forms, for example, a wound-type electrode assembly obtained by winding a positive electrode and a negative electrode stacked with a separator interposed therebetween, or a stacked-type electrode assembly formed from a layered product obtained by stacking a plurality of sheet bodies each including a positive electrode, a negative electrode, and a separator.

### <Specific Configuration of Energy Storage Device>

Next, a nonaqueous electrolyte secondary battery will be described as a specific configuration example of an energy storage device according to an embodiment of the present invention. FIG. 1 is a schematic diagram illustrating the appearance of a prismatic nonaqueous electrolyte secondary battery as an example of an energy storage device. As shown in FIG. 1, the energy storage device 1 includes a flattened rectangular parallelepiped case 3, an electrode assembly 2 housed in the case 3, and a negative electrode external terminal 5 and a positive electrode external terminal 4 provided in the case 3. The case 3 includes a bottomed rectangular tube-shaped case body 31 and an elongated rectangular plate-like case lid body 32 capable of closing an elongated rectangular opening of the case body 31.

The energy storage device 1 includes the electrode assembly 2 housed in the case 3, and a positive current collector 60 and a negative current collector 70 that are electrically connected respectively to both ends of the electrode assembly 2. A leg part 72 extending from a fixing part 71 of the negative current collector 70 is joined to the negative substrate 22 of the electrode assembly 2. In addition, a leg part 62 extending from a fixing part 61 of the positive current collector 60 is joined to the positive substrate 21 of the electrode assembly 2. Thus, the negative electrode external terminal 5 is electrically connected to the electrode assembly 2 via the negative current collector 70, and the positive electrode external terminal 4 is electrically connected to the electrode assembly 2 via the positive current collector 60. More specifically, the leg part 72 of the negative current collector 70 and the negative substrate 22 are, and the leg part 62 of the positive current collector 60 and the positive substrate 21 are joined and then fixed by a joining method such as welding.

The case lid body 32 is provided with the negative electrode external terminal 5 and the positive electrode external terminal 4 that each conduct electricity to an external. The negative electrode external terminal 5 and the positive electrode external terminal 4 are formed of, for example, an aluminum-based metal material such as aluminum or an aluminum alloy. A plate-like upper insulating member 41 and a plate-like upper insulating member 51 are provided respectively between the positive electrode external terminal 4 and the case lid body 32 and between the negative electrode external terminal 5 and the case lid body 32, thereby electrically insulating the negative electrode external terminal 5 and the positive electrode external terminal 4 from the case lid body 32. In addition, a plate-like lower insulating member 42 and a plate-like lower insulating member 52 are provided respectively between the case lid body 32 and the positive current collector 60 and between the case lid body 32 and the negative current collector 70, thereby electrically insulating the positive current collector 60 and the negative current collector 70 from the case lid body 32. The upper insulating member 41, the upper insulating member 51, the lower insulating member 42, and the lower insulating member 52 are all made from a material such as a resin that has electrical insulation properties.

### (Case)

The case 3 includes the case body 31 and the case lid body 32. The case body 31 is a rectangular parallelepiped housing that has an opened upper surface for housing the electrode assembly 2, the positive current collector 60, and the negative current collector 70. In addition, the inside of the case 3 can be sealed by welding or the like the case lid body 32 and the case body 31 after housing one electrode assembly 2 and the like inside. It is to be noted that the materials of the case lid body 32 and case body 31 are not particularly limited, but are preferably, for example, weldable metals such as stainless steel, pure aluminum, and an aluminum alloy.

### (Electrode Assembly)

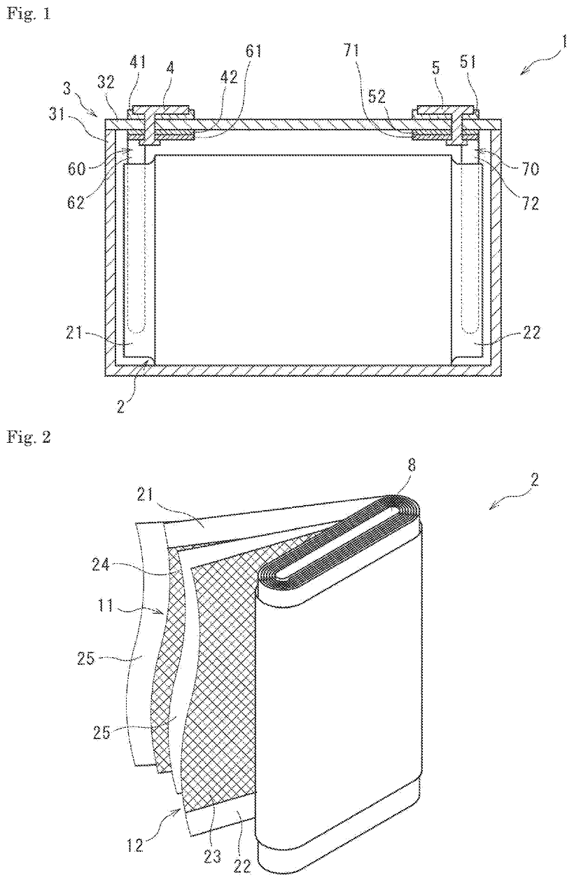

FIG. 2 is a schematic diagram schematically illustrating the electrode assembly 2 in the energy storage device 1. As shown in FIG. 2, the electrode assembly 2 is a wound-type electrode assembly obtained by winding a sheet body including a negative electrode 12, a positive electrode 11 and a separator 25 around a winding core 8 into a flattened form. The electrode assembly 2 is formed by winding, into a flattened form, the positive electrode 11 including a positive active material layer 24 and the negative electrode 12 including a negative active material layer 23 with the separator 25 interposed therebetween. More specifically, in the electrode assembly 2, the strip-shaped separator 25 is formed on the peripheral side of the strip-shaped negative electrode 12, the strip-shaped positive electrode 11 is formed on the peripheral side of the separator 25, and the strip-shaped separator 25 is formed on the peripheral side of the positive electrode 11.

In the electrode assembly 2 configured as described above, more specifically, the negative electrode 12 and the positive electrode 11 are wound while being shifted from each other in the winding axis direction with the separator 25 interposed therebetween. Thus, the negative substrate 22 has an exposed region of the negative substrate 22 where the negative active material layer 23 is not formed at one end in the winding axis direction. This exposed region of the negative substrate 22 serves as a negative electrode connection connected to the negative electrode external terminal 5. In addition, the positive substrate 21 has an exposed region of the positive substrate 21 where the positive active material layer 24 is not formed at the other end in the winding axis direction. This exposed region of the positive substrate 21 serves as a positive electrode connection connected to the positive electrode external terminal 4.

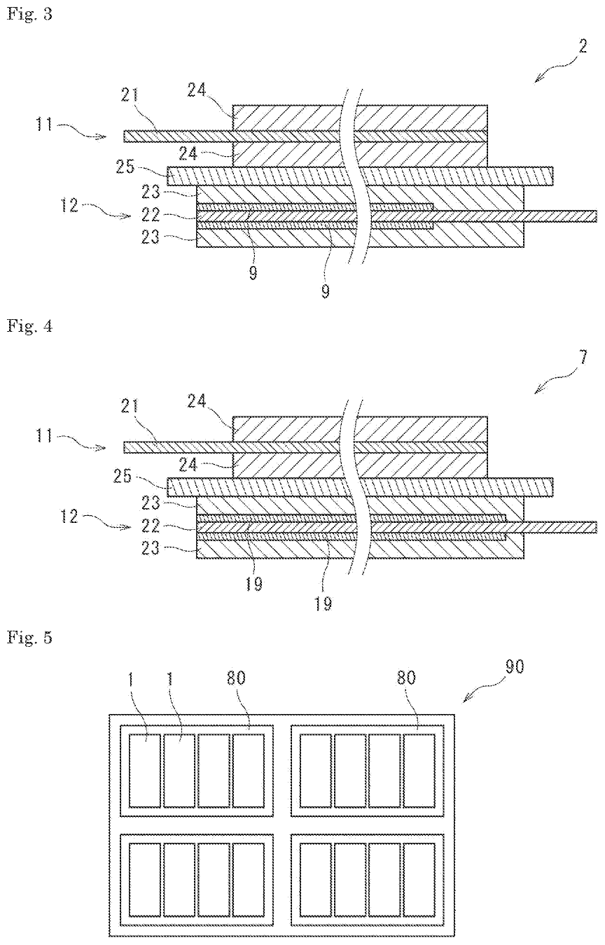

FIG. 3 is a partial cross-sectional view schematically illustrating a part of the electrode assembly 2 of the energy storage device 1. As shown in FIG. 3, the electrode assembly 2 includes the negative electrode 12 and the positive electrode 11 opposed to the negative electrode 12. In the electrode assembly 2, the negative electrode 12 and the positive electrode 11 are disposed with the separator 25 interposed therebetween. The negative electrode 12 includes the negative substrate 22, a conductive layer 9, and the negative active material layer 23, and the negative active material layer 23 is layered on both sides of the negative substrate 22. The negative active material layer 23 is layered on the negative substrate 22 and the conductive layer 9 so as to include a region in contact with the negative substrate 22 and a region in contact with the conductive layer 9. In addition, the positive electrode 11 has the positive substrate 21 and the positive active material layer 24 disposed directly or indirectly on the positive substrate 21. According to the present embodiment, the positive electrode 11 has the positive substrate 21 and the positive active material layer 24, and the positive active material layer 24 is layered on both surfaces of the positive substrate 21.

As described above, preferably, the negative substrate 22 has a negative electrode connection connected to the negative electrode external terminal 5, and a region of the negative active material layer 23 in contact with the negative substrate 22 is located on the negative electrode connection side of the negative substrate 22. The region of the negative active material layer in contact with the negative substrate is located on the negative electrode connection side connected to the negative electrode external terminal, thereby improving an inhibiting effect on the generation of a further charge current at the time of overcharge, and allowing safety at the time of overcharge to be further enhanced.

In addition, for the energy storage device 1, as viewed in the direction in which the negative electrode 12 and the positive electrode 11 are opposed to each other, an end edge of the conductive layer is preferably protruded toward an outer edge side from an end edge of the positive active material layer 24. FIG. 4 is a partial cross-sectional view schematically illustrating a part of an electrode assembly 7 according to another embodiment. In a region of the negative active material layer formed on the conductive layer, the lithium-aluminum alloying reaction in the negative substrate is inhibited by the conductive layer interposed. In addition, in a normal use, lithium ions move in the region where the positive active material layer and the negative active material layer face are opposed to each other. The end edge of the conductive layer 19 is protruded toward the outer edge side from the end edge of the positive active material layer 24 as viewed in the direction in which the negative electrode 12 and the positive electrode 11 are opposed to each other, thereby leading to the conductive layer layered in the region of the negative active material layer 23 opposed to the positive active material layer 24, and thus, in normal use, lithium ions are kept from reaching the negative substrate, and the lithium-aluminum alloying reaction in the negative substrate is inhibited. Because the lithium-aluminum alloying reaction is likely to be developed in the case of charge at a high current density, the energy storage device is particularly effective in the case of charge under conditions of, for example, 5 C or higher. For this reason, in an energy storage device for use as a power source for a hybrid electric vehicle or a power source for starting an idling stop vehicle engine, which requires charge performance at a high current density, the end edge of the conductive layer is preferably protruded to the outer edge side from the end edge of the positive active material layer 24 as viewed in the direction in which the negative electrode 12 and the positive electrode 11 are opposed to each other.

### [Negative Electrode]

The negative electrode 12 includes the negative substrate 22, the conductive layer 9 directly or indirectly layered on the negative substrate 22 and containing a conductive agent, and the negative active material layer 23.

### (Negative Substrate)

The negative substrate 22 has conductivity. Having “conductivity” means that the volume resistivity measured in accordance with JIS-H-0505 (1975) is 1×10⁷ Ω·cm or less, and “non-conductive” means that the volume resistivity is more than 1×10⁷ Ω·cm.

The negative substrate 22 is made of pure aluminum or an aluminum alloy. The negative substrate 22 is made of pure aluminum or an aluminum alloy, thereby leading to favorable durability against overdischarge, lightness in weight, and excellent workability.

The “pure aluminum” refers to aluminum that has a purity of 99.00% by mass or higher, and examples thereof include aluminum of 1000 series prescribed in JIS-H 4000 (2014). In addition, the “aluminum alloy” refers to a metal in which the most contained component is aluminum and the purity of the aluminum is lower than 99.00% by mass, and examples thereof include aluminum other than the 1000 series prescribed in the JIS mentioned above. Examples of the aluminum other than 1000 series prescribed in the JIS include 2000 series aluminum, 3000 series aluminum, 4000 series aluminum, 5000 series aluminum, 6000 series aluminum, and 7000 series aluminum prescribed in the JIS.

The aluminum purity of the negative substrate 22 is preferably 85% by mass or higher, more preferably 90% by mass or higher, even more preferably 95% by mass or higher. As the negative substrate 22, for example, pure aluminum of 1000 series prescribed in JIS-H 4000 (2014), 3000 series aluminum-manganese-based alloys, 5000 series aluminum-magnesium-based alloys, and the like can be used.

Examples of the form of the negative substrate 22 include a foil, and a vapor deposition film, and a foil is preferred from the viewpoint of cost.

The upper limit of the average thickness of the negative substrate 22 may be, for example, 30 μm, but is preferably 20 μm, and more preferably 15 μm. By setting the average thickness of the negative substrate 22 to be equal to or less than the upper limit, the energy density can be further increased. On the other hand, the lower limit of the average thickness may be, for example, 1 μm or 5 μm. It is to be noted that the “average thickness of a substrate” refers to a value obtained by dividing the cutout mass in cutout of a substrate having a predetermined area by the true density and cutout area of the substrate. The average thickness of the “positive substrate” described later is similarly defined.

### [Conductive Layer]

The conductive layer 9 is a coating layer on the surface of the negative substrate 22, and contains conductive particles such as carbon particles to reduce contact resistance between the negative substrate 22 and the negative active material layer 23. In addition, the negative substrate 22 made of pure aluminum or an aluminum alloy has poor coatability with negative composites, but including the conductive layer can improve the coatability with negative composites. Accordingly, including the conductive layer 9 can improve the performance of the energy storage device. The configuration of the conductive layer 9 is not particularly limited but can be formed of, for example, a composition containing a binder and a conductive agent.

The conductive agent contained in the conductive layer 9 is not particularly limited as long as the agent has conductivity. Examples of the conductive agent include carbon black such as furnace black, acetylene black, and ketjen black, natural or artificial graphite, metals, and conductive ceramics. Among these examples, carbon black is preferable as the conductive agent. The shape of the conductive agent is typically particulate.

The lower limit of the content of the conductive agent in the conductive layer 9 is, for example, preferably 20% by mass, more preferably 40% by mass. The content of the conductive agent in the conductive layer 9 is equal to or more than the above lower limit, thereby allowing favorable conductivity to be exhibited in normal use. The upper limit of the content of the conductive agent in the conductive layer 9 is preferably 90% by mass, more preferably 70% by mass. The upper limit of the content of the conductive agent in the conductive layer 9 falls within the above range, thereby making it possible to achieve both the effect of reducing the contact resistance between the negative substrate 22 and the negative active material layer 23 and the effect of improving the coatability with negative composites.

### (Binder)

Examples of the binder in the conductive layer 9 include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; polysaccharide polymers such as cellulosic resins and chitosan-based resins; and acrylic resins. Among these examples, cellulosic resins, chitosan-based resins, and acrylic resins are preferable. These binders are less likely to swell with respect to nonaqueous electrolytes (nonaqueous electrolyte solutions), and capable of effectively inhibiting the lithium-aluminum alloying reaction of the negative substrate in normal use. The cellulosic resins and the chitosan-based resins may be cellulose derivatives or chitosan derivatives subjected to hydroxyalkylation, carboxyalkylation, sulfuric acid esterification, or the like. Examples of the cellulose derivatives can include a carboxymethyl cellulose, a hydroxyethyl cellulose, and a hydroxypropyl methyl cellulose. These derivatives may be salts. Examples of the acrylic resins include a polyacrylic acid, a polymethacrylic acid, a polyitaconic acid, a poly(meth)acryloylmorpholine, a poly N,N-dimethyl (meth)acrylamide, a poly N,N-dimethylaminoethyl(meth)acrylate, a poly N,N-dimethylaminopropyl(meth)acrylamide, and a polyglycerin (meth)acrylate.

The lower limit of the content of the binder in the conductive layer 9 is preferably 10% by mass, more preferably 30% by mass. The upper limit of this content is preferably 80% by mass, more preferably 60% by mass. The content of the binder in the conductive layer 9 falls within the above range, thereby allowing adequate binding properties to be favorably exhibited, and allowing the lithium-aluminum alloying reaction of the negative substrate in normal use to be effectively inhibited.

The average thickness of the conductive layer 9 is not particularly limited, but the lower limit thereof is preferably 0.1 μm, more preferably 0.3 μm. The upper limit of the average thickness is preferably 3 μm, more preferably 2 μm. The average thickness of the conductive layer 9 is set to be equal to or more than the above lower limit, thereby making it possible to achieve both the effect of inhibiting the lithium-aluminum alloying reaction of the negative substrate in normal use and the effect of improving the coatability with negative composites. The average thickness of the conductive layer 9 is set to be equal to or less than the above upper limit, thereby making it possible to provide a negative electrode in which lithium ions are more likely to permeate the conductive layer, and in which the lithium-aluminum alloying reaction on the negative substrate at the time of overcharge is less likely to be inhibited. The average thickness of the conductive layer 9 refers to a value obtained by randomly measuring and averaging the thickness of the conductive layer 9 at twenty or more points.

### [Negative Active Material Layer]

The negative active material layer 23 is disposed along at least one surface of the negative substrate 22, with the conductive layer 9 interposed therebetween. The negative active material layer 23 is formed of a so-called negative composite containing a negative active material.

The negative active material layer 23 contains optional components such as a conductive agent, a binder (binding agent), a thickener, a filler, or the like as necessary.

As the negative active material, a material capable of absorbing and releasing lithium ions is typically used. The energy storage device 1 according to the present embodiment contains a negative active material capable of occluding lithium ions at a potential of 0.05 V vs. Li/Li⁺ or lower. The negative active material layer 23 contains the negative active material capable of occluding lithium ions at a potential of 0.05 V vs. Li/Li⁺ or lower, thereby possibly depositing metal lithium when the charged state of the energy storage device is increased. The energy storage device 1 according to the present embodiment makes the lithium-aluminum alloying reaction more likely to proceed in the region with the negative active material layer in contact with the negative substrate to inhibit the deposition of metallic lithium, thus allowing the safety of the energy storage device at the time of overcharge to be further improved.

Examples of the negative active material include a carbon material. Examples of the carbon material include graphite such as natural graphite and artificial graphite, and non-graphitic carbon. Examples of the non-graphitic carbon include hardly graphitizable carbon (hard carbon), easily graphitizable carbon (soft carbon), and amorphous carbon (amorphous carbon). The term “hardly graphitizable carbon” refers to a non-graphitic carbon that is a carbonaceous material in which the average grid distance (d₀₀₂) of the (002) plane, determined by the X-ray diffraction method before charge-discharge or in the discharged state is 0.36 nm or more (0.36 nm or more and 0.42 nm or less). The hardly graphitizable carbon is typically unlikely to form a graphite structure having a three-dimensional lamination regularity among non-graphitic carbon (unlikely to be converted into graphite, for example, even by heating to an ultrahigh temperature around 3300 K under normal pressure). Examples of the hardly graphitizable carbon include a phenolic resin fired body, a furan resin fired body, a furfuryl alcohol resin fired body, a coal tar fired body, a coke fired body, and a plant fired body. In addition, the “easily graphitizable carbon” is a carbonaceous material in which the average grid distance (d₀₀₂) is 0.34 nm or more and less than 0.36 nm. The easily graphitizable carbon is typically likely to form a graphite structure having a three-dimensional lamination regularity among non-graphitic carbon (likely to be converted into graphite, for example, by high-temperature treatment temperature around 3300 K under normal pressure). Examples of the easily graphitizable carbon include coke and pyrolytic carbon. The “graphite” refers to a carbon material in which the average grid distance (d₀₀₂) is 0.33 nm or more and less than 0.34 nm. Artificial graphite is preferable from the viewpoint that a material having stable physical properties can be obtained. Here, the “discharged state” refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge-discharge are sufficiently released from the carbon material that is the negative active material.

The negative active material is preferably hardly graphitizable carbon or easily graphitizable carbon. The hardly graphitizable carbon or the easily graphitizable carbon has a higher discharge capacity at a potential that is higher than the potential at which the lithium-aluminum alloying reaction is developed, as compared with other carbon materials such as natural graphite or artificial graphite. The negative active material is hardly graphitizable carbon or easily graphitizable carbon, thereby allowing the capacity density of the energy storage device 1 to be increased.

The lower limit of the content of the carbon material with respect to the total mass of the negative active material is preferably 60% by mass and more preferably 80% by mass. By setting the content of the carbon material to be equal to or more than the above lower limit, the capacity density of the energy storage device 1 can be further increased. In contrast, the upper limit of the content of the carbon material with respect to the total mass of the negative active material may be, for example, 100% by mass.

### (Other Negative Active Materials)

The negative active material layer 23 may contain other negative active materials besides the carbon material. The other negative electrode active materials that may be contained besides the carbon material is not particularly limited as long as the materials are negative active materials capable of occluding lithium ions at a potential of 0.05 V vs. Li/Li⁺ or lower. Examples of the material capable of occluding lithium ions at a potential of 0.05 V vs. Li/Li⁺ or lower include metals or semimetals such as Si and Sn, and metal oxides or semimetal oxides such as a Si oxide and a Sn oxide. The phrase “capable of occluding lithium ions” means being capable of occluding lithium ions in normal use of the energy storage device, and does not encompass any case where lithium ions are occluded only if the energy storage device is charged (overcharged) beyond the normal use.

### (Other Optional Components)

While the carbon material also has conductivity, the negative active material layer may contain a conductive agent. Examples of the conductive agent include carbonaceous materials, metals, and conductive ceramics. Examples of the carbonaceous materials include graphite, non-graphitized carbon, and graphene-based carbon. Examples of the non-graphitized carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the conductive agent include a powdery shape and a fibrous shape. As the conductive agent, one of these materials may be used singly, or two or more thereof may be mixed and used. These materials may be composited and used. For example, a material obtained by compositing carbon black with CNT may be used. Among them, carbon black is preferable, an in particular, acetylene black is preferable, from the viewpoint of electron conductivity and coatability. When a conductive agent is used in the negative active material layer, the ratio of the conductive agent to the entire negative active material layer can be about 8.0% by mass or less, and is preferably typically about 5.0% by mass or less (e.g. 1.0% by mass or less).

Examples of the binder include: thermoplastic resins such as a fluororesin (polytetrafluoroethylene (PTFE), polyvinylidene fluoride (PVDF), etc.), a polyethylene, a polypropylene, a polyacrylic acid, and a polyimide; elastomers such as an ethylene-propylene-diene rubber (EPDM), sulfonated EPDM, a styrene-butadiene rubber (SBR), and a fluororubber; and polysaccharide polymers.

The content of the binder in the negative active material layer is preferably 1% by mass or more and 10% by mass or less, more preferably 3% by mass or more and 9% by mass or less. When the content of the binder is within the above-described range, the negative active material particles can be stably held.

Examples of the thickener include polysaccharide polymers such as carboxymethylcellulose (CMC) and methylcellulose. When the thickener has a functional group that is reactive with lithium and the like, the functional group may be deactivated by methylation or the like in advance.

The filler is not particularly limited. Examples of the main component of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof. When a filler is used in the negative active material layer, the ratio of the filler to the entire negative active material layer can be about 8.0% by mass or less, and is preferably typically about 5.0% by mass or less (e.g. 1.0% by mass or less).

### [Positive Electrode]

The positive electrode 11 includes the positive substrate 21 and the positive active material layer 24. The positive active material layer 24 contains a positive active material, and is layered directly or with a conductive layer interposed, along at least one surface of the positive substrate 21.

The positive substrate 21 has conductivity. As the material of the positive substrate 21, a metal such as aluminum, titanium, tantalum, stainless steel, or an alloy thereof is used. Among these, aluminum and aluminum alloys are preferable from the viewpoint of the balance among electric potential resistance, high conductivity, and cost. Examples of the form of the positive substrate 21 include a foil and a vapor deposited film, and a foil is preferable from the viewpoint of cost. In other words, an aluminum foil is preferable as the positive substrate 21. Examples of the aluminum or aluminum alloy include A1085 and A3003 prescribed in JIS-H4000 (2014).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. When the average thickness of the positive substrate is within the above-described range, it is possible to enhance the energy density per volume of the nonaqueous electrolyte energy storage device while increasing the strength of the positive substrate.

The positive active material layer 24 is formed of a so-called positive composite containing a positive active material. In addition, the positive active material layer 24 contains optional components such as a conductive agent, a binder, a thickener, a filler, or the like as necessary.

The positive active material can be appropriately selected from, for example, known positive active materials. As the positive active material for a lithium ion nonaqueous electrolyte secondary battery, a material capable of storing and releasing lithium ions is typically used. Examples of the positive active material include lithium-transition metal composite oxides having an α-NaFeO₂-type crystal structure, lithium-transition metal oxides having a spinel-type crystal structure, polyanion compounds, chalcogenides, and sulfur. Examples of the lithium transition metal composite oxide having an α-NaFeO₂ type crystal structure include Li[LiₓNi₁₋ₓ]O₂ (0≤x<0.5), Li[LiₓNi_{γ}Co_{(1-x-γ)}]O₂ (0≤x<0.5, 0<γ<1), Li[LiₓCo₍₁₋ₓ₎]O₂ (0≤x<0.5), Li[LiₓNi_{γ}Mn_{(1-x-γ)}]O₂ (0≤x<0.5, 0<γ<1), Li[LiₓNi_{γ}Mn_{ß}Co_{(1-x-γ-ß)}]O₂ (0≤x<0.5, 0<γ, 0<ß, 0.5<γ+ß<1), and Li[LiₓNi_{γ}Co_{ß}Al_{(1-x-γ-ß)}]O₂ (0≤x<0.5, 0<γ, 0<ß, 0.5<γ+ß<1). Examples of the lithium-transition metal composite oxides having a spinel-type crystal structure include LiₓMn₂O₄ and LiₓNi_{γ}Mn_{(2-γ)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. A part of atoms or polyanions in these materials may be substituted with atoms or anion species composed of other elements. The surfaces of these materials may be coated with other materials. In the positive active material layer, one of these materials may be used singly, or two or more thereof may be used in mixture. In the positive active material layer, one of these compounds may be used singly, or two or more thereof may be used in mixture.

The lithium transition metal composite oxide is more likely to cause a rapid increase in temperature with the production of metal lithium dendrite as compared with a polyanion compound or the like, and thus in the case of using the lithium transition metal composite oxide as the positive active material, the configuration according to the present embodiment is more preferably applied from the viewpoint of enhancing safety at the time of overcharge.

The content of the positive active material in the positive active material layer is not particularly limited, but the lower limit thereof is preferably 50% by mass, more preferably 80% by mass, still more preferably 90% by mass. On the other hand, the upper limit of this content is preferably 99% by mass, more preferably 98% by mass.

The conductive agent is not particularly limited so long as being a conductive material. Such a conductive agent can be selected from the materials exemplified for the negative electrode. In the case of using a conductive agent, the ratio of the conductive agent to the entire positive active material layer can be about 1.0% by mass to 20% by mass, and is preferably typically about 2.0% by mass to 15% by mass (e.g. 3.0% by mass to 6.0% by mass).

The binder can be selected from the materials exemplified for the negative electrode. When a binder is used, the ratio of the binder to the entire positive active material layer can be about 0.50% by mass to 15% by mass, and is preferably typically about 1.0% by mass to 10% by mass (e.g. 1.5% by mass to 3.0% by mass).

Examples of the thickener include polysaccharide polymers such as carboxymethylcellulose (CMC) and methylcellulose. When the thickener has a functional group reactive with lithium, it is preferable to deactivate the functional group by methylation or the like in advance. When a thickener is used, the ratio of the thickener to the entire positive active material layer can be about 8% by mass or less, and is preferably typically about 5.0% by mass or less (e.g. 1.0% by mass or less).

The filler can be selected from the materials exemplified for the negative electrode. When a filler is used, the ratio of the filler to the entire positive active material layer can be about 8.0% by mass or less, and is preferably typically about 5.0% by mass or less (e.g. 1.0% by mass or less).

The conductive layer is a coating layer on the surface of the positive substrate 21, and contains conductive particles such as carbon particles to decrease contact resistance between the positive substrate 21 and the positive active material layer 24. Similarly to the negative electrode 12, the configuration of the conductive layer is not particularly limited and can be formed of, for example, a composition containing a resin binder and conductive particles.

### [Nonaqueous Electrolyte]

As the nonaqueous electrolyte, a known nonaqueous electrolyte normally used for a general nonaqueous electrolyte secondary battery (energy storage device) can be used. The nonaqueous electrolyte contains a nonaqueous solvent and an electrolyte salt dissolved in the nonaqueous solvent. The nonaqueous electrolyte may be a solid electrolyte or the like.

As the nonaqueous solvent, it is possible to use a known nonaqueous solvent typically used as a nonaqueous solvent of a general nonaqueous electrolyte for an energy storage device. Examples of the nonaqueous solvent include cyclic carbonate, chain carbonate, ester, ether, amide, sulfone, lactone, and nitrile. Among these, it is preferable to use at least the cyclic carbonate or the chain carbonate, and it is more preferable use the cyclic carbonate and the chain carbonate in combination. When the cyclic carbonate and the chain carbonate are used in combination, the volume ratio of the cyclic carbonate to the chain carbonate (cyclic carbonate:chain carbonate) is not particularly limited but is preferably from 5:95 to 50:50, for example.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, catechol carbonate, 1-phenylvinylene carbonate, and 1,2-diphenylvinylene carbonate, and among these, EC is preferable.

Examples of the chain carbonate include diethyl carbonate (DEC), dimethyl carbonate (DMC), ethyl methyl carbonate (EMC), and diphenyl carbonate, and among these, EMC is preferable.

As the electrolyte salt, it is possible to use a known electrolyte salt typically used as an electrolyte salt of a general nonaqueous electrolyte for an energy storage device. Examples of the electrolyte salt include a lithium salt, a sodium salt, a potassium salt, a magnesium salt, and an onium salt, and a lithium salt is preferable.

Examples of the lithium salt include inorganic lithium salts such as LiPF₆, LiPO₂F₂, LiBF₄, LiClO₄, and LiN(SO₂F)₂, and lithium salts having a hydrocarbon group in which hydrogen is replaced by fluorine, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these, an inorganic lithium salt is preferable, and LiPF₆ is more preferable.

The lower limit of the concentration of the electrolyte salt in the nonaqueous electrolyte is preferably 0.1 mol/dm³, more preferably 0.3 mol/dm³, still more preferably 0.5 mol/dm³, particularly preferably 0.7 mol/dm³. On the other hand, the upper limit is not particularly limited, and is preferably 2.5 mol/dm³, more preferably 2.0 mol/dm³, still more preferably 1.5 mol/dm³.

Other additives may be added to the nonaqueous electrolyte. As the nonaqueous electrolyte, a salt that is melted at normal temperature, an ionic liquid, or the like can also be used.

### [Separator]

As the separator 25, for example, a woven fabric, a nonwoven fabric, a porous resin film, and the like are used. Among these, a porous resin film is preferable from the viewpoint of strength, and a nonwoven fabric is preferable from the viewpoint of liquid retaining property of the nonaqueous electrolyte. As a main component for the separator 25, for example, a polyolefin such as polyethylene or polypropylene is preferable from the viewpoint of strength, and for example, polyimide or aramid is preferable from the viewpoint of resistance to oxidative decomposition. These resins may be composited.

An inorganic layer may be disposed between the separator 25 and the positive electrode 11. This inorganic layer is a porous layer, which is also called a heat resistant layer and the like. A separator having an inorganic layer formed on one surface both surfaces of the porous resin film can also be used. The inorganic layer is typically composed of inorganic particles and a binder and may contain other components.

### [Method for Manufacturing Energy Storage Device]

A method for manufacturing an energy storage device according to an embodiment of the present invention includes, for example, housing, in a case, an electrode assembly obtained by staking: a negative electrode including the negative substrate described above, a conductive layer directly or indirectly layered on the negative substrate and containing a conductive agent, and a negative active material layer; and a positive electrode, and a nonaqueous electrolyte solution containing lithium ions. The negative active material layer can be formed by applying a negative composite paste onto the surfaces of the negative substrate and conductive layer and drying the paste. The negative composite paste typically includes a binder and a dispersion medium besides the negative active material, and includes other optional components. As the dispersion medium, an organic solvent is typically used. Examples of the organic solvent include polar solvents such as N-methyl-2-pyrrolidone (NMP), acetone, and ethanol, and nonpolar solvents such as xylene, toluene, and cyclohexane, and polar solvents are preferable, and NMP is more preferable. The negative composite paste can be obtained by mixing the components mentioned above. As described above, the negative active material layer includes a negative active material capable of occluding lithium ions at a potential of 0.05 V vs. Li/Li⁺ or lower. In addition, the negative substrate is pure aluminum or an aluminum alloy.

The method for manufacturing an energy storage device includes, as another step, laminating the negative electrode and the positive electrode via a separator, for example. An electrode assembly is formed by laminating the negative electrode and the positive electrode via the separator.

A method for housing the electrode assembly, the nonaqueous electrolyte solution, and the like into the case can be performed in accordance with a known method.

The energy storage device is capable of improving safety at the time of overcharge and the performance of the energy storage device.

### Other Embodiments

The energy storage device of the present invention is not limited to the embodiments described above, and various changes may be made without departing from the scope of the present invention. For example, the configuration according to one embodiment can be added to the configuration according to another embodiment, or a part of the configuration according to one embodiment can be replaced with the configuration according to another embodiment or a well-known technique. Furthermore, a part of the configuration according to one embodiment can be removed. In addition, a well-known technique can be added to the configuration according to one embodiment.

The shape of the energy storage device according to the present invention is not to be considered particularly limited, and examples thereof include cylindrical batteries, flat batteries, coin batteries, and button batteries besides the prismatic batteries described above.

In the above embodiment, the energy storage device is a nonaqueous electrolyte solution secondary battery, but other energy storage devices may be used. Examples of the other energy storage devices include capacitors (electric double-layer capacitors and lithium ion capacitors). Examples of the nonaqueous electrolyte solution secondary battery include a lithium ion nonaqueous electrolyte solution secondary battery.

The present invention can also be realized as an energy storage apparatus including a plurality of the energy storage devices. An energy storage unit can be constituted using one or a plurality of energy storage devices (cells) of the present invention, and an energy storage apparatus can be constituted using the energy storage unit. The energy storage apparatus can be used as a power source for an automobile, such as an electric vehicle (EV), a hybrid vehicle (HEV), or a plug-in hybrid vehicle (PHEV). The energy storage apparatus can be used for various power source apparatuses such engine starting power source apparatuses, auxiliary power source apparatuses, and uninterruptible power systems (UPSs).

FIG. 5 shows an example of an energy storage apparatus 90 formed by assembling energy storage units 80 in each of which two or more electrically connected energy storage devices 1 are assembled. The energy storage apparatus 90 may include a busbar (not illustrated) for electrically connecting two or more energy storage devices 1 and a busbar (not illustrated) for electrically connecting two or more energy storage units 80. The energy storage unit 80 or the energy storage apparatus 90 may include a state monitor (not illustrated) for monitoring the state of one or more energy storage devices.

### INDUSTRIAL APPLICABILITY

The energy storage device according to the present invention is suitably used as an energy storage device including a nonaqueous electrolyte solution secondary battery used as a power source for electronic devices such as personal computers and communication terminals, automobiles, and the like, besides a power source for a hybrid electric vehicle or a power source for starting an idling stop vehicle engine.

### DESCRIPTION OF REFERENCE SIGNS

1: energy storage device

2, 7: electrode assembly

3: case

4: positive electrode external terminal

5: negative electrode external terminal

8: winding core

9, 19: conductive layer

11: positive electrode

12: negative electrode

21: positive substrate

22: negative substrate

23: negative active material layer

24: positive active material layer

25: separator

31: case body

32: case lid body

41: upper insulating member

42: lower insulating member

51: upper insulating member

52: lower insulating member

60: positive current collector

61: fixing part

62: leg part

70: negative current collector

71: fixing part

72: leg part

80: energy storage unit

90: energy storage apparatus

1. An energy storage device comprising:
a negative electrode comprising a negative substrate comprising pure aluminum or an aluminum alloy, a conductive layer directly or indirectly layered on the negative substrate and comprising a conductive agent, and a negative active material layer comprising a negative active material capable of occluding lithium ions at a potential of 0.05 V vs. Li/Li⁺ or lower; and
a positive electrode opposed to the negative electrode and comprising a positive substrate and a positive active material layer directly or indirectly layered on the positive substrate, wherein
the negative active material layer is layered on the negative substrate and the conductive layer to comprise a region in contact with the negative substrate and a region in contact with the conductive layer.

2. The energy storage device according to claim 1, wherein as viewed in a direction in which the negative electrode and the positive electrode are opposed to each other, an end edge of the conductive layer is protruded toward an outer edge side from an end edge of the positive active material layer.

3. The energy storage device according to claim 1, further comprising a negative electrode external terminal and a positive electrode external terminal that each conduct electricity to an external,
the negative substrate has a negative electrode connection connected to the negative electrode external terminal, and
a region of the negative active material layer in contact with the negative substrate is located on a negative electrode connection side of the negative substrate.

4. The energy storage device according to claim 1, wherein the negative active material is hardly graphitizable carbon or easily graphitizable carbon.
